(19) United States
(12) Patent Application Publication
(10) Pub. No.: US 2026/0192230 A1
(43) Pub. Date: Jul. 9, 2026

(54) SOUND ABSORBER FOR AIR CLEANER, AND AIR CLEANER

(71) Applicant: TOYOTA BOSHOKU KABUSHIKI KAISHA, Aichi-ken (JP)

(72) Inventor: Hiroyuki YOSHIMURA, Nagoya-shi (JP)

(73) Assignee: TOYOTA BOSHOKU KABUSHIKI KAISHA, Aichi-ken (JP)

(21) Appl. No.: 19/437,473

(22) Filed: Dec. 31, 2025

(30) Foreign Application Priority Data
Jan. 7, 2025 (JP) 2025-002183

(51) Int. Cl. B01D 46/42; F02M 35/02; F02M 35/12

(52) U.S. Cl. CPC B01D 46/4236; F02M 35/0201; F02M 35/1272; B01D 2279/60

(57) ABSTRACT

A sound absorber for an air cleaner is configured to be attached to an inner wall of a case of an air cleaner for an internal combustion engine. The sound absorber for the air cleaner includes a body having a sound absorbing layer, and includes an attachment configured to be attached to the inner wall such that an air layer is formed between the body and the inner wall. The sound absorbing layer is formed of a thermoplastic resin nonwoven fabric, and has air permeability. The shape retaining layer is laminated on the sound absorbing layer and thermally pressed so as to be bonded to fibers of the sound absorbing layer, thereby maintaining a shape of the sound absorbing layer. The shape retaining layer includes a through-hole extending through the shape retaining layer in a thickness direction of the shape retaining layer.

### CROSS-REFERENCE TO RELATED APPLICATIONS

This application is based upon and claims the benefit of priority from Japanese Patent Application No. 2025-002183, filed on January 7, 2025, the entire contents of which are incorporated herein by reference.

### BACKGROUND

### 1. Field

The present disclosure relates to a sound absorber for an air cleaner and to an air cleaner.

### 2. Description of Related Art

An intake passage of a vehicle on-board internal combustion engine includes an air cleaner that filters foreign matter contained in intake air.

JP2023-20347A discloses a sound absorbing device for an air cleaner (hereinafter referred to as a sound absorbing device) that reduces intake noise in a vehicle on-board internal combustion engine. The sound absorbing device disclosed in the publication includes a sound absorber formed of a sheet-shaped nonwoven fabric and a guide member that holds the sound absorber. The guide member has a bowl shape provided with ventilation holes, and is accommodated in a case of the air cleaner. The guide member is made of synthetic resin. The sound absorber is attached to the outer surface of the guide member so as to extend along the outer surface. Tabs for locking the sound absorber are provided on the peripheral surface of the guide member.

In the sound absorber for the air cleaner, a reduction in the number of components and a reduction in intake noise at a specific frequency are required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A sound absorber for an air cleaner according to a first aspect of the present disclosure is configured to be attached to an inner wall of a case of an air cleaner for an internal combustion engine to reduce intake noise in the internal combustion engine. The sound absorber includes a body. The body includes an air-permeable sound absorbing layer formed of a thermoplastic resin nonwoven fabric and a shape retaining layer formed of a thermoplastic resin sheet having a lower melting point than the sound absorbing layer. The shape retaining layer is laminated on the sound absorbing layer and then thermally pressed so as to be bonded to fibers of the sound absorbing layer, thereby maintaining a shape of the sound absorbing layer. The sound absorber further includes an attachment formed by thermally pressing a part of the nonwoven fabric and a part of the sheet. The attachment is configured to be attached to the inner wall such that an air layer is formed between the body and the inner wall. The shape retaining layer includes a through-hole extending through the shape retaining layer in a thickness direction of the shape retaining layer.

An air cleaner according to a first aspect of the present disclosure is configured to be provided in an intake passage of an internal combustion engine. The air cleaner includes a case including an inlet, a cap including an outlet, a filter element provided between the case and the cap; and the sound absorber for the air cleaner according. An air layer is formed between the body and the inner wall.

A sound absorber for an air cleaner according to a second aspect of the present disclosure is configured to be attached to an inner wall of a case of an air cleaner for an internal combustion engine to reduce intake noise in the internal combustion engine. The sound absorber includes a body including an air-permeable sound absorbing layer formed of a nonwoven fabric. The nonwoven fabric includes thermoplastic first resin fibers and thermoplastic second resin fibers having a lower melting point than the first resin fibers. The nonwoven fabric is thermally pressed so that the first resin fibers are bonded to each other via the second resin fibers. The sound absorber further includes an attachment formed by thermally pressing a part of the nonwoven fabric. The attachment is configured to be attached to the inner wall such that an air layer is formed between the body and the inner wall. The body includes a through-hole extending through the body in a thickness direction of the sound absorbing layer.

An air cleaner according to a second aspect of the present disclosure is configured to be provided in an intake passage of an internal combustion engine. The air cleaner includes a case including an inlet, a cap including an outlet, a filter element provided between the case and the cap, and the sound absorber for the air cleaner. An air layer is formed between the body and the inner wall.

Other features and aspects will be apparent from the following detailed description, the drawings, and the claims.

### BRIEF DESCRIPTION OF THE DRAWINGS

FIG. 1 is a cross-sectional view of an air cleaner according to a first embodiment.

FIG. 2 is a plan view of the sound absorber shown in FIG. 1.

FIG. 3 is a cross-sectional view showing the body of the sound absorber and the bottom wall of the case taken along line 3-3 of FIG. 2.

FIG. 4 is a graph showing the relationship between the one-third-octave-band center frequency of the intake noise in the air cleaner and the amount of noise reduction.

FIG. 5 is a cross-sectional view showing the body of the sound absorber and the bottom wall of the case according to a second embodiment.

FIG. 6 is a cross-sectional view showing the body of the sound absorber and the bottom wall of the case according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

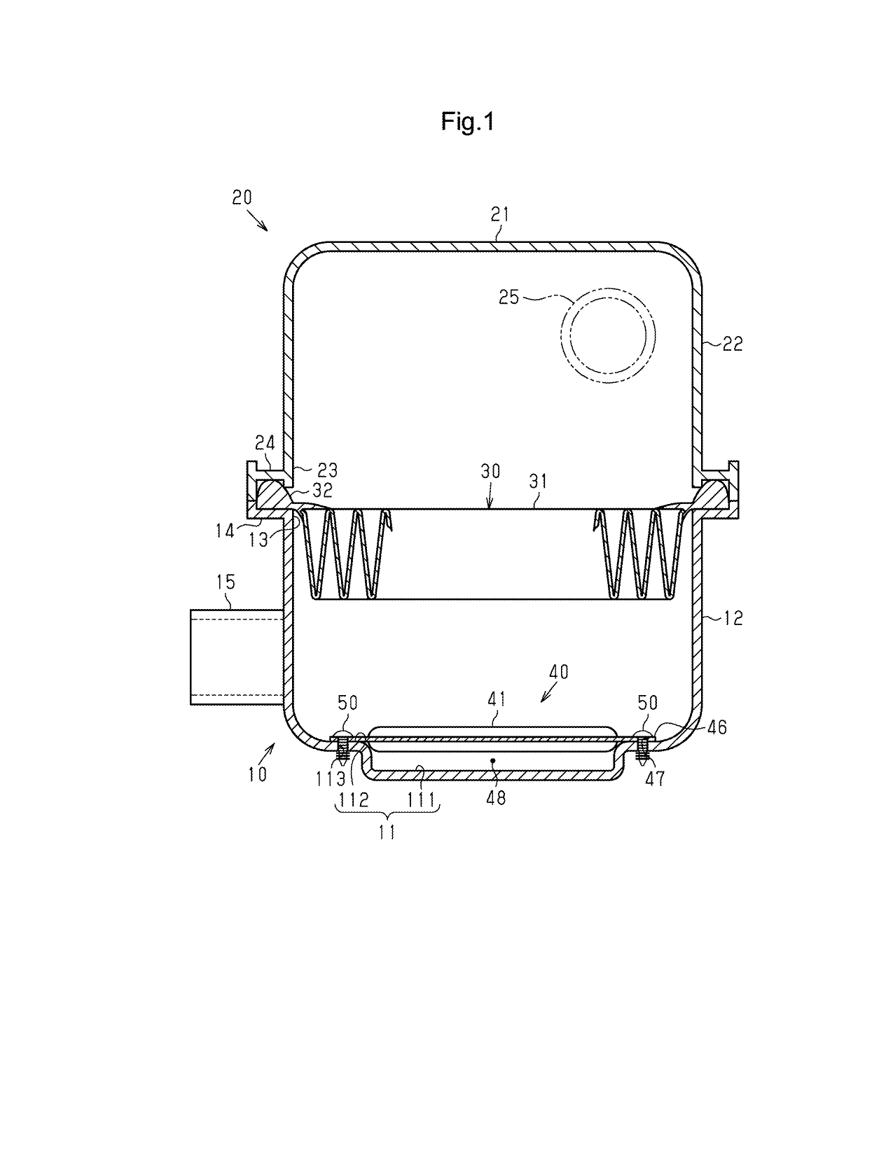

A sound absorber for an air cleaner, and an air cleaner according to a first embodiment will now be described with reference to FIGS. 1 to 4.

Referring to FIG. 1, the air cleaner is provided in an intake passage of a vehicle on-board internal combustion engine. The air cleaner includes a case 10 having an inlet 15, a cap 20 having an outlet 25, a filter element 30 provided between the case 10 and the cap 20, and a sound absorber 40.

### Case 10

The case 10 includes a bottom wall 11, a peripheral wall 12 continuous with a peripheral edge of the bottom wall 11, an opening 13 surrounded by the upper edge of the peripheral wall 12, a flange 14 continuous with the upper edge of the peripheral wall 12, and the inlet 15. The inlet 15 is connected to the peripheral wall 12.

The bottom wall 11 includes an attachment surface 112 to which a sound absorber 40, which will be described later, is attached, and a recess 111 recessed from the attachment surface 112. An attachment hole 113 extends through the bottom wall 11 and opens in the attachment surface 112.

The case 10 is formed of a hard resin material.

### Cap 20

The cap 20 includes a top wall 21, a peripheral wall 22 continuous with the peripheral edge of the top wall 21, an opening 23 surrounded by the lower edge of the peripheral wall 22, a flange 24 continuous with the lower edge of the peripheral wall 22, and the outlet 25. The outlet 25 is connected to the peripheral wall 22.

The cap 20 is formed of a hard resin material.

### Filter Element 30

The filter element 30 includes a filtering portion 31 and a sealing portion 32. The filtering portion 31 has a pleated shape formed by folding a filter medium such as filter paper or a nonwoven fabric. The sealing portion 32 extends over the entire peripheral edge of the filtering portion 31. The sealing portion 32 is formed of a foamed resin material having closed cells.

### Sound Absorber 40

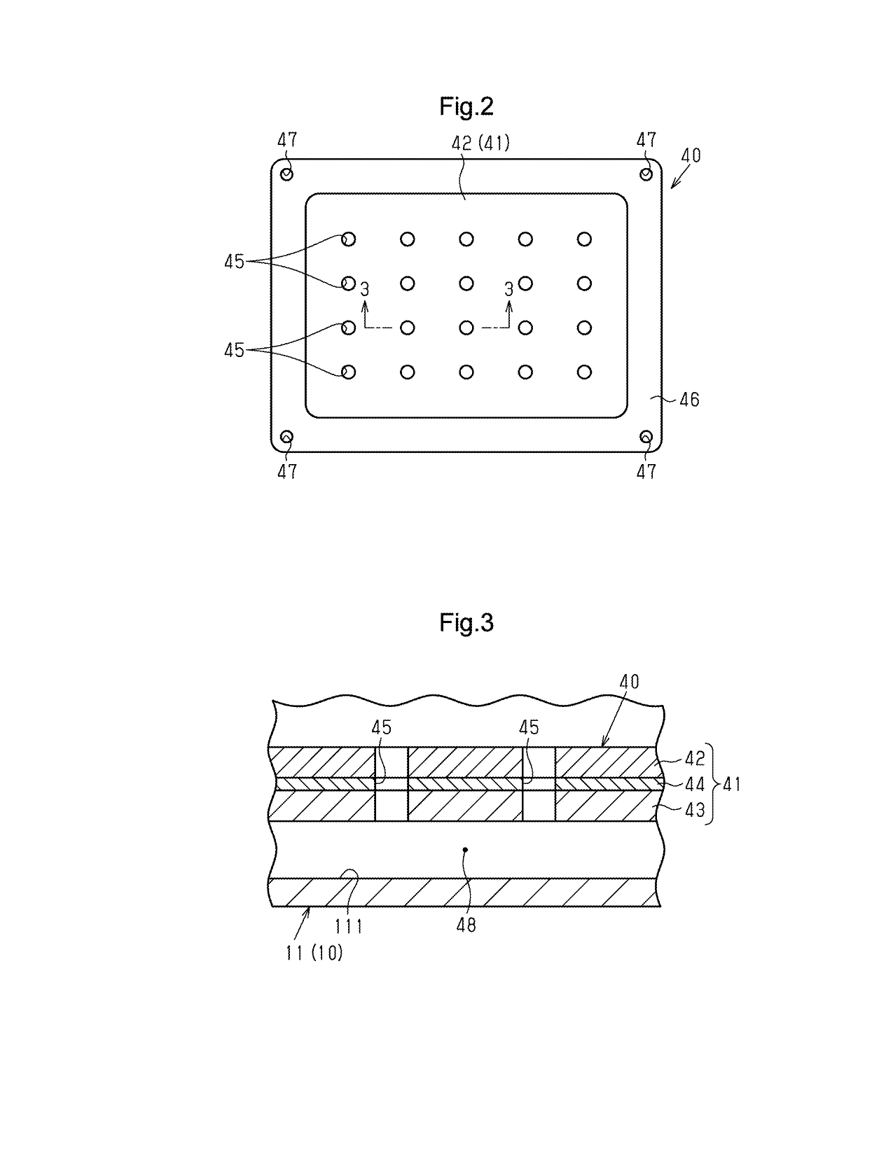

As shown in FIGS. 1 and 2, the sound absorber 40 includes a body 41 and an attachment 46.

As shown in FIG. 2, the sound absorber 40 of the present embodiment has a substantially rectangular shape in plan view. The planar shape of the sound absorber 40 is not limited to a substantially rectangular shape in plan view and may alternatively be, for example, a triangular shape in plan view. The sound absorber 40 may also have a three-dimensional shape including a portion facing the peripheral wall 12 in addition to the bottom wall 11.

As shown in FIG. 3, the body 41 includes sound absorbing layers 42 and 43 (i.e., a first sound absorbing layer 42 and a second sound absorbing layer 43), and a shape retaining layer 44.

The sound absorbing layers 42 and 43 are formed of a thermoplastic resin nonwoven fabric, and have air permeability.

The shape retaining layer 44 is formed of a thermoplastic resin sheet having a lower melting point than the sound absorbing layers 42 and 43. The shape retaining layer 44 is laminated on the sound absorbing layers 42, 43 and thermally pressed so as to be bonded to fibers of the sound absorbing layers 42, 43, thereby maintaining the shapes of the sound absorbing layers 42, 43.

In the present embodiment, the shape retaining layer 44 is sandwiched between the first sound absorbing layer 42 and the second sound absorbing layer 43.

The sound absorbing layers 42 and 43 are made of, for example, polyethylene terephthalate (PET). The shape retaining layer 44 is made of, for example, polyethylene (PE).

The shape retaining layer 44 includes through-holes 45 that extend through the shape retaining layer 44 in its thickness direction.

Each through-hole 45 extends through the shape retaining layer 44 and the sound absorbing layers 42 and 43 in the thickness direction, and has a uniform cross-sectional shape in the thickness direction. The inner diameter of the through-hole 45 of the present embodiment is 8 mm. The interval between adjacent ones of the through-holes 45 is 30 mm.

The attachment 46 is formed by thermally pressing a part of the nonwoven fabric and a part of the sheet. The attachment 46 is attached to the bottom wall 11 such that an air layer 48 is formed between the body 41 and the bottom wall 11.

The bottom wall 11 of the present embodiment corresponds to “an inner wall of a case.”

The attachment 46 of the present embodiment is provided on the peripheral edge of the body 41. The attachment 46 includes holes 47 extending through the attachment 46 in its thickness direction. The attachment 46 is attached to the attachment surface 112 of the bottom wall 11 by inserting an attachment member 50 into each hole 47 of the attachment 46 and the corresponding attachment hole 113 of the bottom wall 11 from the inside of the case 10, with the body 41 covering the recess 111 of the bottom wall 11. The air layer 48 is formed between the body 41 and the recess 111 of the bottom wall 11.

The sound absorber 40 is formed by forming the through-holes 45 and the holes 47 through machining after laminating a sheet, which is used as the shape retaining layer 44, on a nonwoven fabric, which is used as the sound absorbing layers 42 and 43, and thermally pressing the laminate.

### Operation of the Present Embodiment

The body 41 of the sound absorber 40 includes the air-permeable sound absorbing layers 42 and 43, which are formed of a thermoplastic resin nonwoven fabric, and the shape retaining layer 44, which is laminated on the sound absorbing layers 42 and 43. When a sound wave of the intake noise in the internal combustion engine enters the sound absorbing layers 42 and 43, the vibration energy of the sound wave is converted into vibration energy of the fibers of the nonwoven fabric and then converted into thermal energy. As a result, the intake noise is reduced. The foregoing describes a sound absorbing effect.

Further, the sheet used as the shape retaining layer 44 is laminated on the nonwoven fabric used as the sound absorbing layers 42 and 43 and then thermally pressed so as to be bonded to the fibers of the sound absorbing layers 42 and 43. Thus, the shapes of the sound absorbing layers 42 and 43 are maintained.

The sound absorber 40 includes the attachment 46, which is formed by thermally pressing a part of the nonwoven fabric and a part of the sheet. When the attachment 46 is attached to the bottom wall 11 of the case 10 of the air cleaner, the air layer 48 is formed between the body 41 and the bottom wall 11. Thus, the through-holes 45 of the body 41 and the air layer 48 act as a Helmholtz resonator. As a result, the intake noise of a specific frequency in the intake passage is reduced. The foregoing describes a silencing effect.

The specific frequency is defined by the volume of the air layer 48, the cross-sectional area of each through-hole 45, and the length of the through-hole 45 (i.e., the thickness of the body 41).

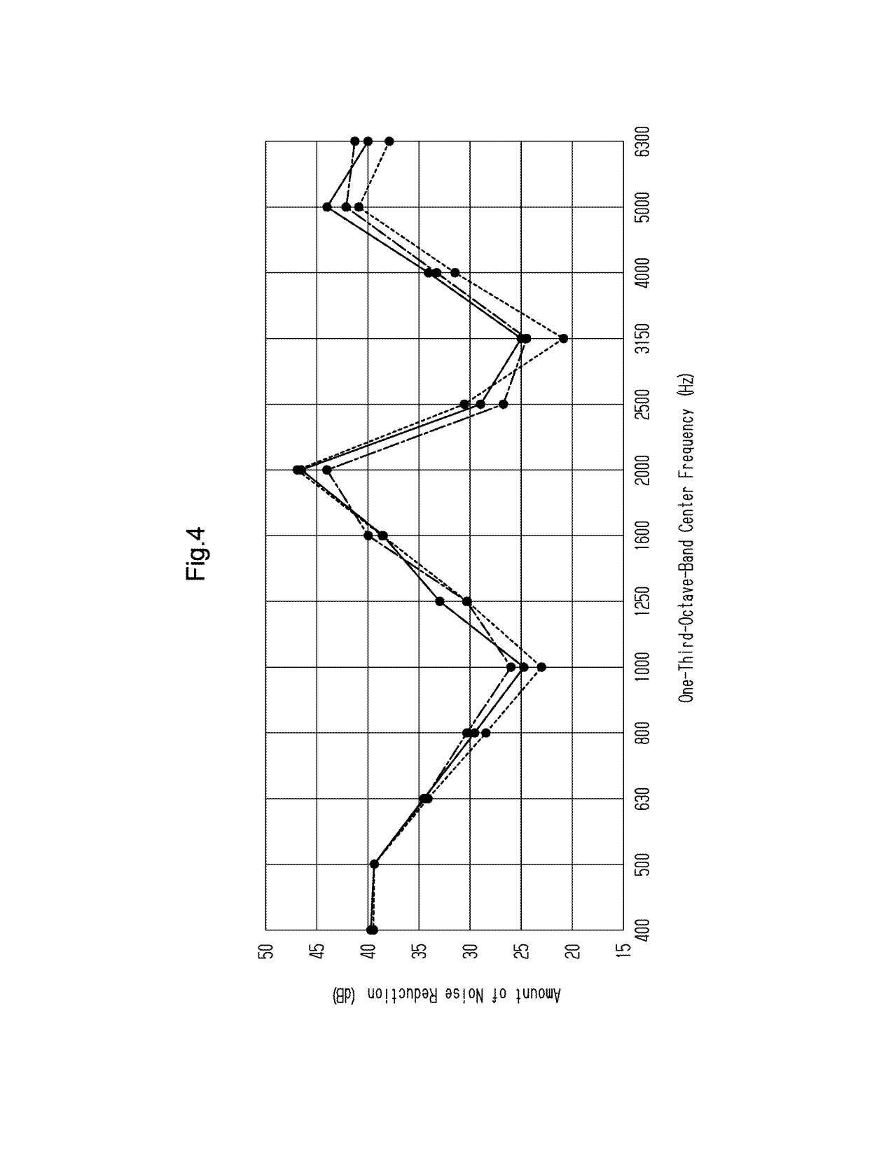

FIG. 4 shows the relationship between the one-third-octave-band center frequency (Hz) of the intake noise in the air cleaner and the amount of noise reduction (dB).

The solid line in FIG. 4 indicates the measurement result for the air cleaner including the sound absorber 40 of the present embodiment. The single-dashed line in FIG. 4 indicates the measurement result for an air cleaner of a first comparative example that includes a sound absorber without through-holes 45. The broken line in FIG. 4 indicates the measurement result for an air cleaner of a second comparative example that does not include a sound absorber.

As indicated by the solid line in FIG. 4, it was confirmed that, in the air cleaner of the present embodiment, the amount of noise reduction at 1250 Hz, 2000 Hz, and 2500 Hz is greater than that in the air cleaner of the first comparative example, which includes the sound absorber without through-holes 45.

### Advantages of the Present Embodiment

(1-1) The sound absorber 40 includes the body 41, which includes the sound absorbing layers 42, 43 and the shape retaining layer 44, and the attachment 46. The shape retaining layer 44 includes the through-holes 45, which extend through the shape retaining layer 44 in its thickness direction.

Such a configuration produces the operation of the above-described embodiment, thereby reducing the number of components and reducing the intake noise at a specific frequency.

(1-2) Each through-hole 45 extends through the shape retaining layer 44 and the sound absorbing layers 42, 43 in the thickness direction, and has a uniform cross-sectional shape in the thickness direction.

In such a configuration, the body 41 is formed by forming the through-holes 45 through machining after laminating a sheet, which is used as the shape retaining layer 44, on a nonwoven fabric, which is used as the sound absorbing layers 42 and 43, and thermally pressing the laminate. This facilitates formation of the sound absorber 40 including the through-holes 45, each having a uniform cross-sectional shape in the thickness direction.

(1-3) The sound absorbing layers 42 and 43 are made of polyethylene terephthalate. The shape retaining layer 44 is made of polyethylene.

In such a configuration, the shape retaining layer 44 made of polyethylene is laminated on the sound absorbing layers 42 and 43 made of polyethylene terephthalate and then thermally pressed so as to be bonded to the fibers of the sound absorbing layers 42 and 43. This facilitates formation of the sound absorber 40.

(1-4) The air cleaner includes the case 10, the cap 20, the filter element 30, and the sound absorber 40. The air layer 48 is formed between the body 41 and the bottom wall 11.

Such a configuration produces the same advantages as those described in (1-1) to (1-3).

### Second Embodiment

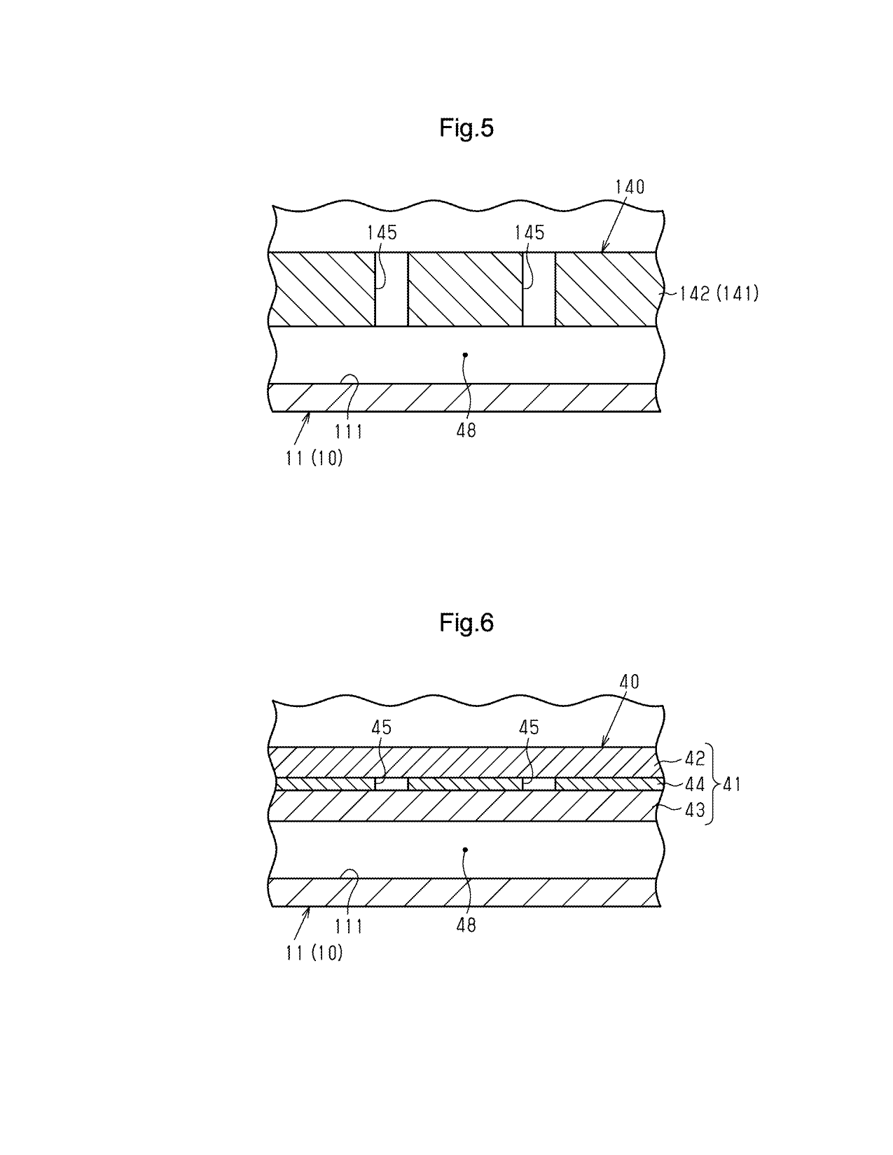

The air cleaner, and the sound absorber for the air cleaner according to the second embodiment will now be described with reference to FIG. 5.

The present embodiment is different from the first embodiment in the configuration of a sound absorber 140. Thus, the following describes differences from the first embodiment.

In the present embodiment, components identical to those in the first embodiment are denoted by the same reference numerals, and components corresponding to those in the first embodiment are denoted by reference numerals obtained by adding 100 to the numerals of the corresponding components in the first embodiment. Redundant explanation may be omitted accordingly.

The sound absorber 140 includes a body 141 and the attachment 46.

The body 141 includes an air-permeable sound absorbing layer 142. The sound absorbing layer 142 is a nonwoven fabric that includes thermoplastic first resin fibers and thermoplastic second resin fibers having a melting point lower than that of the first resin fibers. The nonwoven fabric is thermally pressed so that the first resin fibers are bonded to each other via the second resin fibers.

The attachment 46 is formed by thermally pressing a part of the nonwoven fabric. The attachment 46 is attached to the bottom wall 11 such that the air layer 48 is formed between the body 141 and the bottom wall 11.

The body 141 includes through-holes 145 extending through the body 141 in the thickness direction of the sound absorbing layer 142.

The first resin fiber is polyethylene terephthalate (PET). The second resin fiber is a low–melting point polyethylene terephthalate (PET) having a melting point lower than that of polyethylene terephthalate.

### Operation of the Present Embodiment

The body 141 of the sound absorber 140 is a nonwoven fabric including the first resin fibers and the second resin fibers, and includes the air-permeable sound absorbing layer 142. When a sound wave of the intake noise in the internal combustion engine enters the sound absorbing layer 142, vibration energy of the sound wave is converted into the vibration energy of the fibers of the nonwoven fabric and then converted into thermal energy. As a result, the intake noise is reduced. The foregoing describes a sound absorbing effect.

In addition, the sound absorbing layer 142 is thermally pressed, so that the first resin fibers of the sound absorbing layer 142 are bonded to each other via the second resin fibers. Thus, the shape of the sound absorbing layer 142 is maintained.

The sound absorber 140 includes the attachment 46, which is formed by thermally pressing a part of the nonwoven fabric. When the attachment 46 is attached to the bottom wall 11 of the case 10 of the air cleaner, the air layer 48 is formed between the body 141 and the bottom wall 11. Thus, the through-holes 145 of the body 141 and the air layer 48 act as a Helmholtz resonator. As a result, the intake noise of a specific frequency in the intake passage is reduced. The foregoing describes a silencing effect.

The specific frequency is defined by the volume of the air layer, the cross-sectional area of each through-hole, and the length of the through-hole.

### Advantages of the Present Embodiment

(2-1) The sound absorber 140 includes the body 141, which includes the sound absorbing layer 142, and the attachment 46. The body 141 includes the through-holes 145, which extend through the body 141 in the thickness direction of the sound absorbing layer 142.

Such a configuration produces the operation of the above-described embodiment, thereby reducing the number of components and reducing the intake noise at a specific frequency.

(2-2) The first resin fiber is polyethylene terephthalate. The second resin fiber is a low–melting point polyethylene terephthalate having a melting point lower than that of the polyethylene terephthalate.

In such a configuration, the first resin fibers, which are made of polyethylene terephthalate, are suitably bonded to each other via the second fiber resins, which are made of low-melting-point polyethylene terephthalate. This facilitates formation of the sound absorber 140.

### Modifications

The present embodiment may be modified as follows. The present embodiment and the following modifications can be combined as long as they remain technically consistent with each other.

In the second embodiment, the first resin fiber and the second resin fiber do not have to be polyethylene terephthalate (PET), and may be, for example, polypropylene (PP).

In the first embodiment, one of the first sound absorbing layer 42 and the second sound absorbing layer 43 may be omitted.

In the first embodiment, the sound absorbing layer does not have to be made of polyethylene terephthalate (PET), and may be made of another thermoplastic resin such as polypropylene (PP) or acrylic resin. The nonwoven fabric of the sound absorbing layer may be a mixture of fibers made of multiple types of thermoplastic resins. Further, natural fibers (e.g., hemp) or rayon may be mixed into the nonwoven fabric made of the thermoplastic resin of the sound absorbing layer. The shape retaining layer does not have to be made of polyethylene (PE), and may be made of any thermoplastic resin having a lower melting point than the thermoplastic resin of the sound absorbing layer.

As shown in FIG. 6, in the sound absorber 40 according to a modification, the through-holes 45 may extend through only the shape retaining layer 44, among the components of the body 41 (i.e., the sound absorbing layers 42, 43 and the shape retaining layer 44). Even in this case, since the sound absorbing layers 42 and 43 have air permeability, the through-holes 45 of the body 41 and the air layer 48 act as a Helmholtz resonator. As a result, the intake noise of a specific frequency in the intake passage is reduced. The through-holes 45 may be formed using stress that acts on a thermoplastic resin sheet having a lower melting point than the sound absorbing layers 42 and 43, the stress being produced when a laminate of that sheet and the nonwoven fabric of the sound absorbers 42 and 43 is thermally pressed. Alternatively, the through-holes 45 may be formed in advance in the sheet through, for example, machining.

In the above modification, components identical or corresponding to those of the first embodiment are denoted by the same reference numerals, and redundant explanation is omitted accordingly.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A sound absorber for an air cleaner, the sound absorber being configured to be attached to an inner wall of a case of an air cleaner for an internal combustion engine to reduce intake noise in the internal combustion engine, the sound absorber comprising:
a body including:
an air-permeable sound absorbing layer formed of a thermoplastic resin nonwoven fabric; and
a shape retaining layer formed of a thermoplastic resin sheet having a lower melting point than the sound absorbing layer, the shape retaining layer being laminated on the sound absorbing layer and then thermally pressed so as to be bonded to fibers of the sound absorbing layer, thereby maintaining a shape of the sound absorbing layer; and
an attachment formed by thermally pressing a part of the nonwoven fabric and a part of the sheet, the attachment being configured to be attached to the inner wall such that an air layer is formed between the body and the inner wall, wherein
the shape retaining layer includes a through-hole extending through the shape retaining layer in a thickness direction of the shape retaining layer.

2. The sound absorber for the air cleaner according to claim 1, wherein
the through-hole extends through the shape retaining layer and the sound absorbing layer in the thickness direction, and has a uniform cross-sectional shape in the thickness direction.

3. The sound absorber for the air cleaner according to claim 2, wherein
the sound absorbing layer is made of polyethylene terephthalate, and
the shape retaining layer is made of polyethylene.

4. An air cleaner configured to be provided in an intake passage of an internal combustion engine, the air cleaner comprising:
a case including an inlet;
a cap including an outlet;
a filter element provided between the case and the cap; and
the sound absorber for the air cleaner according to claim 1, wherein
an air layer is formed between the body and the inner wall.

5. A sound absorber for an air cleaner, the sound absorber being configured to be attached to an inner wall of a case of an air cleaner for an internal combustion engine to reduce intake noise in the internal combustion engine, the sound absorber comprising:
a body including an air-permeable sound absorbing layer formed of a nonwoven fabric, the nonwoven fabric including thermoplastic first resin fibers and thermoplastic second resin fibers having a lower melting point than the first resin fibers, and the nonwoven fabric being thermally pressed so that the first resin fibers are bonded to each other via the second resin fibers; and
an attachment formed by thermally pressing a part of the nonwoven fabric, the attachment being configured to be attached to the inner wall such that an air layer is formed between the body and the inner wall, wherein
the body includes a through-hole extending through the body in a thickness direction of the sound absorbing layer.

6. The sound absorber for the air cleaner according to claim 5, wherein
each of the first resin fibers is polyethylene terephthalate, and
each of the second resin fibers is a low-melting-point polyethylene terephthalate having a lower melting point than the polyethylene terephthalate.

7. An air cleaner configured to be provided in an intake passage of an internal combustion engine, the air cleaner comprising:
a case including an inlet;
a cap including an outlet;
a filter element provided between the case and the cap; and
the sound absorber for the air cleaner according to claim 5, wherein
an air layer is formed between the body and the inner wall.
